(19) United States
(12) Patent Application Publication
(10) Pub. No.: US 2012/0287189 A1
(43) Pub. Date: Nov. 15, 2012

(54) IMAGE FORMING DEVICE AND IMAGE FORMING METHOD

(75) Inventors: Yoshitaka SHIMADA, Matsumoto-shi (JP); Mitsuaki YOSHIZAWA, Kamiina-gun (JP)

(73) Assignee: SEIKO EPSON CORPORATION, Tokyo (JP)

(21) Appl. No.: 13/461,004

(22) Filed: May 1, 2012

(30) Foreign Application Priority Data
May 12, 2011 (JP) 2011-107463

(51) Int. Cl. B41J 29/38

(52) U.S. Cl. 347/12

(57) ABSTRACT

An image forming device in which one nozzle row group is positioned out of line to one side in a medium transport direction with respect to other nozzle row groups, including a first mode in which a main image that is formed using either nozzle row group out of the one nozzle row group and the other nozzle row groups and a background image that is formed using the other nozzle row group out of the one nozzle group and the other nozzle row groups are formed on a medium to be overlapping, and a second mode in which the main image is formed on the medium without forming the background image using either nozzle row group out of the one nozzle row group and the other nozzle row groups.

This application claims priority to Japanese Patent Application No. 2011-107463 filed May 12, 2011 which is expressly incorporated herein by reference.

### BACKGROUND

1. Technical Field

The present invention relates to an image forming device and an image forming method.

2. Related Art

Among printers that are image forming devices, there are printers that repeat a discharging action of discharging ink while moving the head in a movement direction and a transport action of transporting a medium in a transport direction that intersects the movement direction. Further, printers that use white ink in addition to color ink such as cyan, magenta, and yellow are known (for example, refer to JP-A-2002-38063). With such a printer, for example, it is possible to form an image in which a white background image is overlapped on a main image by color ink, and it is possible to form a main image with good coloring without being influenced by the base color of the medium.

Further, with a printer in which a plurality of heads are positioned out of line from the transport direction, a main image and a background image can be overlapped and formed by different discharging actions by forming the main image using one out of the plurality of heads and forming the background image using another head. However, in a case when the main image is formed without forming the background image, if the main image is formed using a plurality of heads, the image quality of the main image decreases due to the differences in the characteristics of the heads, for example.

### SUMMARY

An advantage of some aspects of the invention is that a decrease in the image quality of a main image is suppressed.

According to an aspect of the invention, there is provided an image forming device including: a plurality of nozzle row groups in which one nozzle row group is positioned out of line with respect to other nozzle row groups to one side in a predetermined direction, wherein the plurality of nozzle rows in each of the nozzle row groups are lined up in a direction that intersects the predetermined direction, and a plurality of nozzles that discharge ink are lined up in the predetermined direction and the plurality of nozzles in each of the nozzle rows are in communication with a common ink chamber; and a control unit that repeatedly executes a discharge action of discharging ink from the nozzles while relatively moving the plurality of nozzle row groups and a medium in the intersecting direction and a transport action of moving the relative position of the medium with respect to the plurality of nozzle row groups in the predetermined direction, the device including a first mode of overlapping and forming a main image that is formed using either nozzle row group out of the one nozzle row group and the other nozzle row groups and a background image that is formed using the other nozzle row group out of the one nozzle row group and the other nozzle row groups on the medium, and a second mode of forming the main image on the medium without forming the background image using one nozzle row group out of the one nozzle row group and the other nozzle row groups.

### BRIEF DESCRIPTION OF THE DRAWINGS

The invention will be described with reference to the accompanying drawings, wherein like numbers reference like elements.

FIG. 1A is an overall configuration block diagram of a printer.

FIG. 1B is an outline perspective diagram of the printer.

FIG. 2A is a diagram that describes the surroundings of a carriage.

FIG. 2B is a cross-sectional diagram in which the yellow nozzle row of a head is seen in the movement direction.

FIG. 3 is a diagram that describes the printing modes that the printer includes.

FIGS. 4A and 4B are diagrams that describe the printing method of a white use mode.

FIGS. 5A and 5B are diagrams that describe the printing method of a single mode.

FIG. 6 is a diagram that describes the printing pattern of an adoption candidate.

FIG. 7 is a diagram that describes the printing pattern of another adoption candidate.

FIG. 8 is a diagram that describes the printing pattern of another adoption candidate.

FIG. 9 is a diagram that describes the printing pattern of another adoption candidate.

FIG. 10 is a diagram that describes the printing pattern of another adoption candidate.

FIG. 11 is a diagram that illustrates the evaluation results of printing patterns 1 to 5 that are adoption candidates at image quality level 2 in the white use mode.

FIG. 12 is a diagram that describes a printing pattern table that is stored in the memory.

FIG. 13 is the flow of a printing method according to the printer of the embodiment.

FIG. 14A is a diagram that describes the placement of the head of a modification example, and FIG. 14B is a diagram that describes a printing method of the modification example.

### DESCRIPTION OF EXEMPLARY EMBODIMENTS

### Outline of Disclosure

At least the following will be made clear by the description of the specification and the description of the attached drawings.

That is, an image forming device includes: a plurality of nozzle row groups in which one nozzle row group is positioned out of line with respect to other nozzle row groups to one side in a predetermined direction, wherein the plurality of nozzle rows in each of the nozzle row groups are lined up in a direction that intersects the predetermined direction, and a plurality of nozzles that discharge ink are lined up in the predetermined direction and the plurality of nozzles in each of the nozzle rows are in communication with a common ink chamber; and a control unit that repeatedly executes a discharge action of discharging ink from the nozzles while relatively moving the plurality of nozzle groups and a medium in the intersecting direction and a transport action of moving the relative position of the medium with respect to the plurality of nozzle row groups in the predetermined direction, and includes a first mode of overlapping and forming a main image that is formed using either nozzle row group out of the one nozzle row group and the other nozzle row groups and a background image that is formed using the other nozzle row group out of the one nozzle row group and the other nozzle row groups on the medium, and a second mode of forming the main image on the medium without forming the background image using one nozzle row group out of the one nozzle row group and the other nozzle row groups.

According to such an image forming device, a decrease in the image quality of the main image can be suppressed.

With such an image forming device, the control unit moves the relative position of the medium with respect to the plurality of nozzle row groups to the one side in the predetermined direction in the transport action, and the image forming device includes a third mode of forming an image that is visible from the image formation side in the first mode, wherein the main image is formed using either nozzle row group and the background image is formed using the other nozzle row group, and a fourth mode of forming an image that is visible from the opposite side to the image formation side in the first mode, wherein the background image is formed using either nozzle row group and the main image is formed using the other nozzle row group, wherein a dot formation pattern in a case when the main image is formed using the one nozzle row group in the second mode is the same as the dot formation pattern of forming the main image in the third mode, and the dot formation pattern in a case when the main image is formed using the other nozzle row group in the second mode is the same as the dot formation pattern of forming the main image in the fourth mode.

According to such an image forming device, the image quality of the main image can be homogenized regardless of the mode. Further, for example, it is possible to simplify the process of determining the optimum dot formation pattern or to reduce the storage capacity of the memory that stores the dot formation pattern.

With such an image forming device, the control unit moves the relative position of the medium with respect to the plurality of nozzle row groups to the one side in the predetermined direction in the transport action, and the image forming device includes a third mode of forming an image that is visible from the image formation side in the first mode, wherein the main image is formed using the one nozzle row group and the background image is formed using the other nozzle row groups, and a fourth mode of forming an image that is visible from the opposite side to the image formation side in the first mode, wherein the background image is formed using the one nozzle row group and the main image is formed using the other nozzle row groups, wherein the main image is formed using the one nozzle row group in a case when an image that is visible from the image formation side is formed in the second mode, and the main image is formed using the other nozzle row groups in a case when an image that is visible from the opposite side to the image formation side is formed in the second mode.

According to such an image forming device, deviations in the use frequencies of the one nozzle row group and other nozzle groups can be reduced. Further, by making the dot formation patterns the same in a case when the nozzle row groups that form the main image are the same, the dot formation patterns can be made the same in a case when the sides from which the image is viewed are the same, and the dot formation pattern with the fastest possible printing speed while reliably suppressing a decrease in the image quality of the main image can be adopted.

With such an image forming device, ink that is discharged from the plurality of nozzles is photocurable ink that is cured when light is irradiated, and the image forming device includes a light irradiation unit that irradiates light on the photocurable ink, which is placed to extend from an end portion to the one side in the predetermined direction of the one nozzle group to an end portion of the other side in the predetermined direction of the other nozzle row groups in at least the predetermined direction, wherein in the discharge action, the control unit relatively moves the light irradiation unit, the plurality of nozzle row groups, and the medium in the intersecting direction, and the one nozzle row group and the other nozzle row groups are positioned out of line in the intersecting direction.

According to such an image forming device, even in a case when the difference in the image quality of images tends to increase depending on the nozzle row groups, a decrease in the image quality of the main image can be suppressed.

With such an image forming device, a non-discharge region in which the ink is not discharged is provided between the one nozzle row group and the other nozzle row groups in the predetermined direction.

According to such an image forming device, the length of time between a lower layer image being formed and an upper layer image being formed to be overlapping can be increased. Accordingly, it is possible to overlap the upper layer image in a state in which the lower layer image has been sufficiently cured and dried, and a decrease in the image quality of the image can be suppressed.

Further, an image forming method includes: a plurality of nozzle row groups in which one nozzle row group is positioned out of line with respect to other nozzle row groups to one side in a predetermined direction, wherein the plurality of nozzle rows in each of the nozzle row groups are lined up in a direction that intersects the predetermined direction, and a plurality of nozzles that discharge ink are lined up in the predetermined direction and the plurality of nozzles in each of the nozzle rows are in communication with a common ink chamber; and a control unit that repeatedly executes a discharge action of discharging ink from the nozzles while relatively moving the plurality of nozzle groups and a medium in the intersecting direction and a transport action of moving the relative position of the medium with respect to the plurality of nozzle row groups in the predetermined direction, wherein in a case when a main image and a background image are formed on the medium to be overlapping, the main image is formed using either nozzle row group out of the one nozzle row group and the other nozzle row groups, and the background image is formed using the other nozzle row group out of the one nozzle row group and the other nozzle row groups, and in a case when the main image is formed on the medium without forming the background image, the main image is formed using either nozzle row group out of the one nozzle row group and the other nozzle row groups.

According to such an image forming method, a decrease in the image quality of the main image can be suppressed.

### Printing System

Embodiments will be described with a printing system in which the image forming device is an ink jet printer (hereinafter, printer) and in which the printer and a computer are connected as an example.

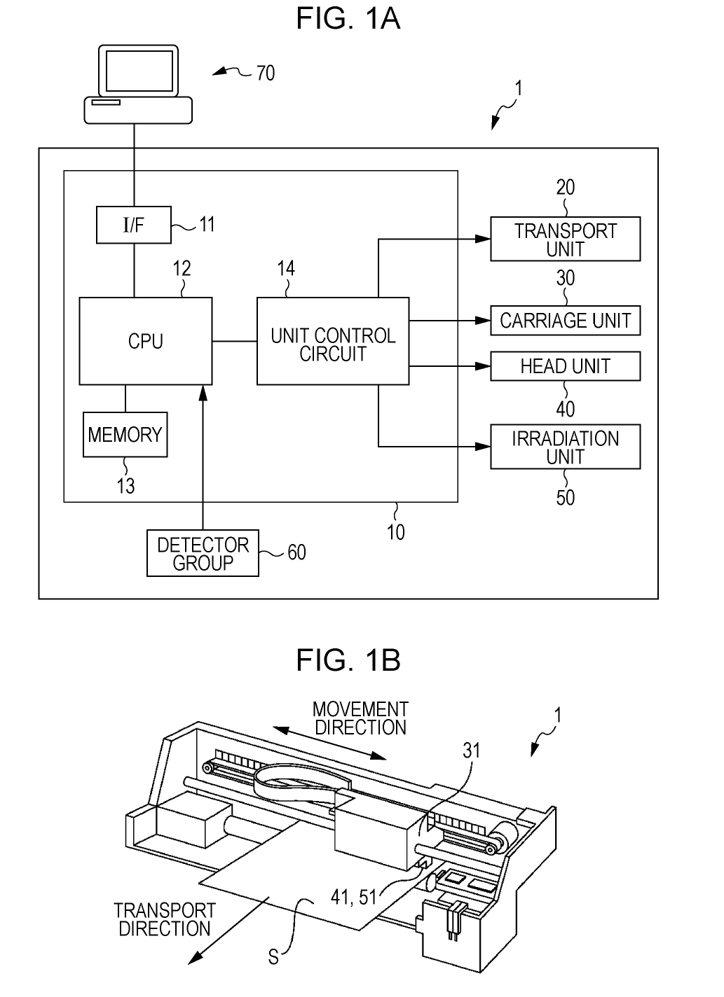

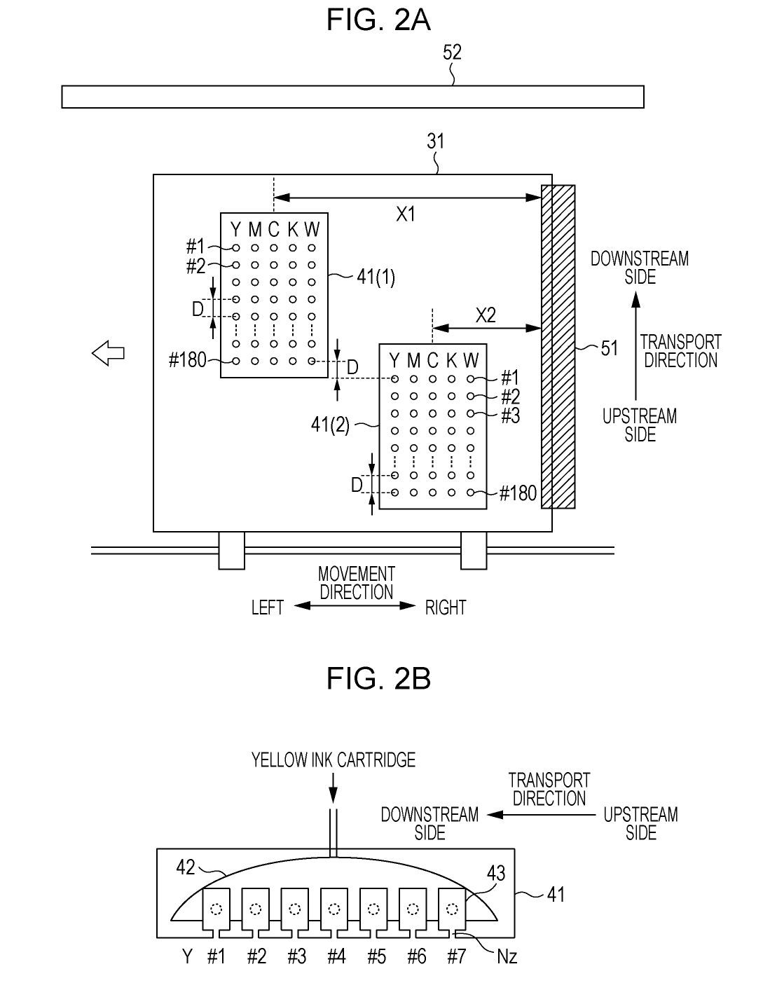

FIG. 1A is an overall configuration block diagram of a printer 1, FIG. 1B is an outline perspective diagram of the printer 1, FIG. 2A is a diagram that describes the surroundings of a carriage 31, and FIG. 2B is a cross-sectional diagram in which a yellow nozzle row Y of a head 41 is viewed in the movement direction. Here, the arrangement of nozzles that are viewed from above the head 41 are virtually illustrated in FIG. 2A, and the number of nozzles that belong to a nozzle row is reduced to seven in FIG. 2B.

The printer 1 of the embodiment forms an image on a medium S (examples: paper, cloth, film) by discharging ultraviolet curable ink that is cured by the irradiation of ultraviolet rays. Here, ultraviolet curable ink (hereinafter, UV ink) is ink that includes an ultraviolet curable resin, and is cured by the occurrence of a photopolymerization reaction in the ultraviolet curable resin when irradiation of ultraviolet rays is received.

A computer 70 is communicably connected to the printer 1, and outputs printing data that is created by a printer driver to the printer 1.

The controller 10 is a control unit for performing control of the printer 1. An interface unit 11 is for performing transceiving of data between the computer 70 and the printer 1. A CPU 12 is a computation processing device for performing control of the entirety of the printer 1. A memory 13 is for securing a region in which programs of the CPU 12 are stored, a work region, and the like. A CPU 12 controls each unit by a unit control circuit 14. Here, the state within the printer 1 is monitored by a detector group 60, and the controller 10 controls each unit based on the detection results thereof.

A transport unit 20 is for sending the medium S to a printable position, and for transporting the medium S in the transport direction at a predetermined transport rate during printing.

A carriage unit 30 is for moving the head 41 and the like that are installed on the carriage 31 in a movement direction that intersects the transport direction.

A head unit 40 is for discharging ink onto the medium S, and includes two heads 41 (first head 41 (1) and second head 41 (2)). As illustrated in FIG. 2A, five nozzle rows each with a plurality of nozzles that discharge ink which are lined up in the transport direction with predetermined intervals (nozzle pitch D) are formed on the lower face of each head 41. For the sake of description, out of the nozzles that belong to each nozzle row, numbers are given in order of nozzles from the downstream side of the transport direction (#1, #2 . . . #180).

The printer 1 of the embodiment is able to discharge ink of five colors (YMCK and W), and a yellow nozzle row Y that discharges yellow ink, a magenta nozzle row M that discharges magenta ink, a cyan nozzle row C that discharges cyan ink, a black nozzle row K that discharges black ink, and a white nozzle row W that discharges white ink are formed on the lower face of each head 41. That is, each head 41 includes a “nozzle row group (YMCK and W) in which a plurality of nozzle rows are lined up in the movement direction.

Furthermore, as illustrated in FIG. 2B, a plurality of nozzles Nz that belong to each nozzle row are in communication with the same “common ink chamber 42”. That is, the common ink chamber 42 is provided for each nozzle row, and is for retaining the ink that is supplied from ink cartridges (ink supply sources) to the head 41. Further, a “pressure chamber 43” is provided between the common ink chamber 42 and the nozzles Nz or each nozzle Nz. A pressure chamber 43 is in communication with both the common ink chamber 42 and a nozzle Nz. In such a manner, the plurality of nozzles (#1 to #180) that belong to the same nozzle row are in communication with the same common ink chamber 42, and the plurality of nozzle that belong to a different nozzle row are not in communication with one another, and are in communication with a different common ink chamber 42.

Here, the ink discharge method from the nozzles may be a piezo method in which ink is discharged from the nozzles by expanding and contracting a pressure chamber 43 through application of a voltage to a driving element (piezo element), or may be a thermal method in which ink is discharged from the nozzles by bubbles, through generation of bubbles within the nozzles using a heating element.

Further, the first head 41 (1) (equivalent to one nozzle row group) is positioned to be out of line on the left side of the movement direction with respect to the second head 41 (2) (equivalent to other nozzle row groups) and to be out of line to the downstream side of the transport direction (equivalent to one side of the predetermined direction). Further, a nozzle #1 that is positioned furthest to the downstream side of the transport direction on the second head 41 (2) is positioned to the upstream side of the transport direction by the nozzle pitch D with respect to a nozzle #180 that is position furthest to the upstream side of the transport direction on the first head 41 (1). Accordingly, a plurality of nozzles are lined up in the transport direction with intervals of the nozzle pitch D in a state in which the first head 41 (1) and the second head 41 (2) are together.

However, without being limited thereto, an end portion on the upstream side of the transport direction of the first head 41 (1) may overlap an end portion on the downstream side of the transport direction of the second head 41 (2). For example, the positions in the transport direction of the two end portion nozzles on the upstream side in the transport direction of the first head 41 (1) (#179 and #180) may be made the same as the two end portion nozzles on the downstream side in the transport direction of the second head 41 (2) (#1 and #2).

An irradiation unit 50 is for curing the UV ink by irradiating ultraviolet rays on UV ink that has landed on the medium S, and includes a provisional irradiation unit 51 and a main irradiation unit 52. Here, examples of the light source for ultraviolet irradiation include a light emitting diode (LED), a metal halide lamp, a mercury lamp, and the like.

The provisional irradiation unit 51 moves in the movement direction together with the two heads 41 along with the movement of the carriage 31. In the embodiment, a printing method in which ink is discharged from the nozzles only when the two heads 41 move on the left side of the movement direction (so-called unidirectional printing) is executed. Accordingly, as illustrated in FIG. 2A, the provisional irradiation unit 51 is provided at the end portion on the right side of the movement direction of the carriage 31 (end portion to the opposite side to the side to which the carriage 31 moves during ink discharge). Here, in a case when a printing method in which ink is discharged from the nozzles when the carriage 31 moves in both directions of the movement direction (so-called bidirectional printing) is executed, the provisional irradiation unit 51 may be provided on both end portions of the movement direction of the carriage 31.

The provisional irradiation unit 51 extends in the transport direction similarly to the nozzle rows that are provided on the head 41. Accordingly, the UV ink that is discharged from the two heads 41 that are moving in the movement direction is irradiated by ultraviolet rays by the provisional irradiation unit 51 as soon as the UV ink lands on the medium.

The main irradiation unit 52 is provided fixed further to the downstream side of the transport direction than the carriage 31. The length of the main irradiation unit 52 in the movement direction is equal to or greater than the length of the medium S in the movement direction, and the main irradiation unit 52 irradiates ultraviolet rays on the UV ink on the medium S that passes through underneath. Accordingly, the UV ink on the medium S is completely cured by the main irradiation unit 52.

With such a printer 1, the controller 10 (equivalent to the control unit) repeatedly executes a discharge action of discharging ink from the nozzles by moving the two heads 41 (equivalent to the plurality of nozzle row groups) and the provisional irradiation unit 51 in the movement direction (equivalent to the intersecting direction) with respect to the medium and a transport action of transporting the medium to the downstream side of the transport direction with respect to the two heads 41. As a result, since dots are formed in a later discharge action at positions on the medium S which are different to the positions of the dots that are formed by the earlier discharge action, a two-dimensional image is printed (image is formed) on the medium S. Hereinafter, one discharge action will be referred to as a “pass”.

### Printing Modes

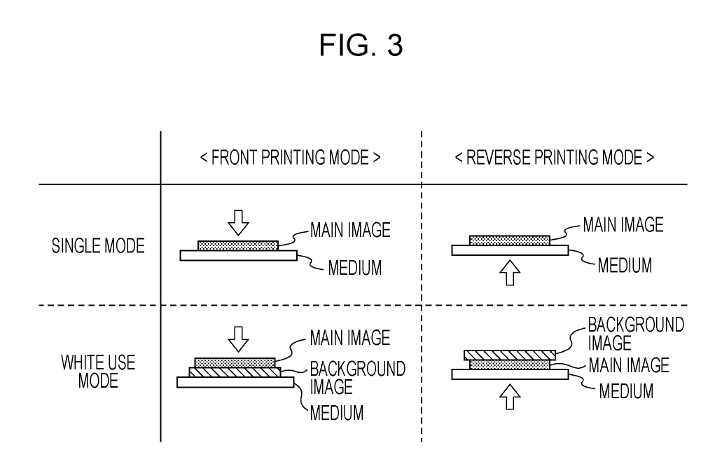

FIG. 3 is a diagram that describes the printing modes that the printer 1 includes. The printer 1 of the embodiment includes a “single mode” that forms a “main image” that is a monochrome image using black ink (K) or a color image using four colors of ink (YMCK) alone, and a “white use mode” in which a “background image” using white ink (W) and the “main image” are formed to be overlapping.

By printing by overlapping the main image and the background image as with the white use mode, it is possible, for example, to improve the coloring of the main image in a case when the medium is not white, or the prevent the opposite side of the main image from showing through in a case when the medium is transparent.

The single mode and the white use mode are further categorized into a “front printing mode” in which the image (main image) is to be seen from the printing face side and a “reverse printing mode” in which the image is printed to be seen from the opposite side to the printing face side via the medium. That is, the printer 1 includes a front printing single mode, a front printing white use mode, a reverse printing single mode and a reverse printing white use mode.

Here with the “front printing white use mode”, the background image is formed first on a predetermined region of the medium before the main image, and the main image is formed over the background image. With the “reverse printing white use mode”, the main image is formed first on a predetermined region of the medium before the background image, and the background image is formed over the main image.

### Outline of Printing Method

### White Use Mode

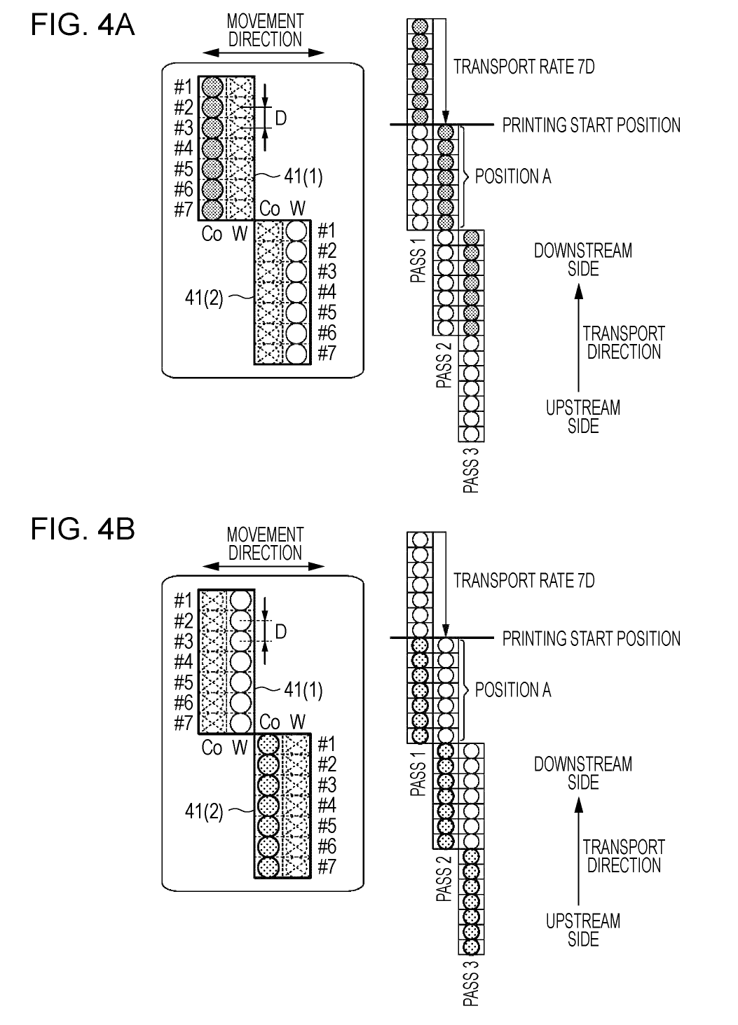

FIGS. 4A and 4B are diagrams that describe the printing method of the white use mode. In the drawings, in order to simplify description, the number of nozzles that belong to one nozzle row is reduced to seven (#1 to #7), and the nozzle rows that discharge each of the four colors of ink (YMCK) are collectively illustrated as a “color nozzle row Co”.

Here, band printing is given as an example. Band printing is a printing method in which band images that are formed by one pass are lined up in the transport direction, and is a printing method in which raster lines by other passes are not printed between raster lines that are printed by a given pass (dot row along the movement direction).

FIG. 4A is a diagram that describes the printing method of the “front printing white use mode”. In the case of the front printing white use mode, as illustrated in the diagram on the left of FIG. 4A, the color nozzle row Co of the first head 41 (1) is a “nozzle row for main image” for forming the main image, a white nozzle row W of the first head 41 (1) is an “unused nozzle row”, the color nozzle row Co of the second head 41 (2) is an “unused nozzle row”, and the white nozzle row W of the second head 41 (2) is a “nozzle row for background image” for forming the background image.

With band printing, since the length of one image that is printed by one pass in the transport direction is equivalent to the medium transport rate, here, the medium transport rate is 7 D. Furthermore, by repeating a discharge action of printing an image by the nozzle setting described above and a transport action of transporting the medium to the downstream side of the transport direction at the transport rate of 7 D, printing is performed as the diagram on the right of FIG. 4A. Here, although the medium is transported to the downstream side of the transport direction with respect to the head 41 in reality, in the diagram on the right of FIG. 4A, the head 41 is illustrated out of line to the upstream side of the transport direction in order to illustrate the relative positional relationship of the head 41 at each pass. Further, in the diagram on the right of FIG. 4A, the nozzle row Co for the main image and the nozzle row W for the background image are illustrated as one nozzle row.

For example, in the diagram on the right of FIG. 4A, the part of the medium of which the position in the transport direction is a position A faces the nozzle row for the background image (W of the second head 41 (2)) in pass 1, and the background image is formed on the part of the medium at the position A. In pass 2 that follows, the part of the medium at the position A faces the nozzle row for the main image (Co of the first head 41 (1)), and the main image is formed to be overlapping on the background image of the part of the medium at the position A.

FIG. 4B is a diagram that describes the printing method of the “reverse printing white use mode”. In the case of the reverse printing white use mode, as illustrated in the diagram on the left of FIG. 4B, the color nozzle row Co of the first head 41 (1) is an “unused nozzle row”, the white nozzle row W of the first head 41 (1) is the “nozzle row for the background image, the color nozzle row Co of the second head 41 (2) is the “nozzle row for the main image”, and the white nozzle row W of the second head 41 (2) is an “unused nozzle row”.

As a result, printing is performed as the diagram on the right of FIG. 4B. For example, the part of the medium at the position A faces the nozzle row for the main image (Co of the second head 41 (2)) in pass 1, and the main image is formed on the part of the medium at the position A. In pass 2 that follows, the part of the medium at the position A faces the nozzle row for the background image (W of the first head 41 (1)), and the background image is formed to be overlapping on the main image of the part of the medium at the position A.

In such a manner, with the white use mode, a lower layer image that is formed first on a predetermined region of the medium is formed by the second head 41 (2) to the upstream side of the transport direction, and an upper layer image that is later formed on the predetermined region of the medium is formed by the first head 41 (1) to the downstream side of the transport direction. In so doing, since the predetermined region first faces the second head 41 (2) that forms the lower layer image, the upper image is formed to be overlapping on the lower layer image. That is, the main image and the background image can be formed to be overlapped by different passes in order according to the front printing and reverse printing modes.

### Single Mode

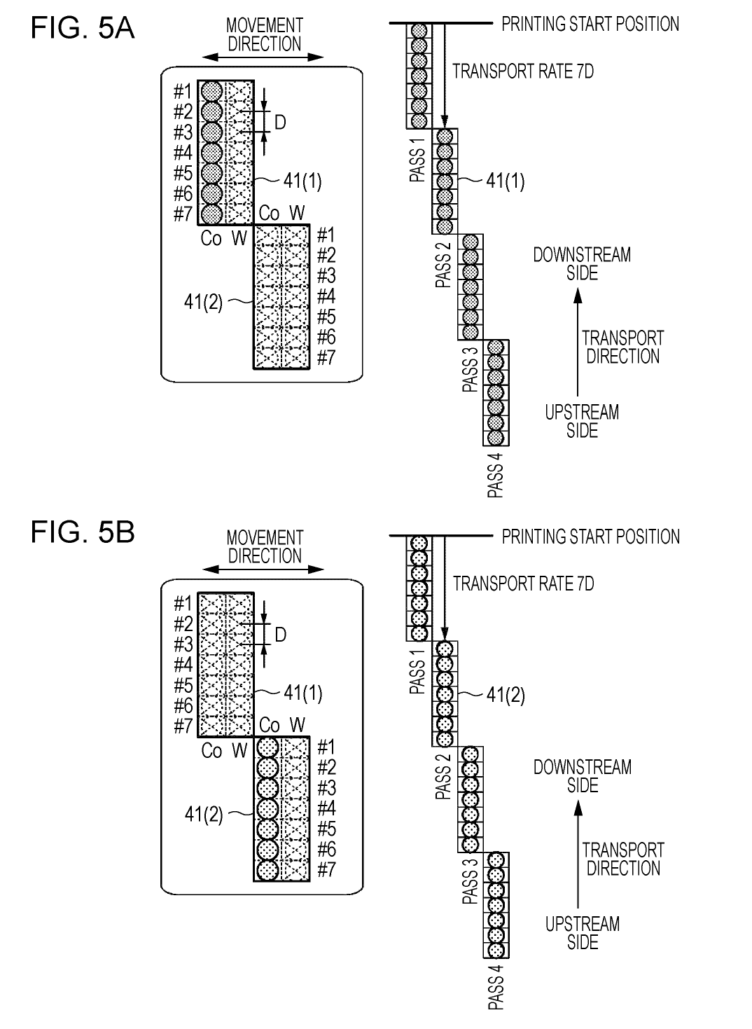

FIGS. 5A and 5B are diagrams that describe the printing method of the single mode. FIG. 5A is a diagram that describes the printing method of a “front printing single mode”. With the front printing single mode, only the first head 41 (1) is used. In more detail, the color nozzle row Co of the first head 41 (1) is the “nozzle row for the main image”, and the white nozzle row W of the first head 41 (1) and the color nozzle row Co and the white nozzle row W of the second head 41 (2) are “unused nozzle rows”. Therefore, in a case when band printing is executed, similarly to the white use mode, the medium transport rate becomes “7 D”. As a result, as illustrated in the diagram on the right of FIG. 5A, the background image is not formed, and only the main image is formed on the medium.

FIG. 5B is a diagram that describes the printing method of the “reverse printing single mode”. With the reverse printing single mode, only the second head 41 (2) is used. In more detail, the color nozzle row Co of the second head 41 (2) is the “nozzle row for the main image”, and the color nozzle row Co and the white nozzle row W of the first head 41 (1) and the white nozzle row W of the second head 41 (2) are “unused nozzle rows”. As a result, as illustrated in the diagram on the right of FIG. 5B, the background is not formed, and only the main image is formed on the medium.

In such a manner, with the single mode, the main image is formed using only one head 41 out of the first head 41 (1) and the second head 41 (2), and the other head 41 is not used. Further, with the “front printing single mode”, the first head 41 (1) that forms the main image with the “front printing white use mode” is used, and with the “reverse printing single mode”, the second head 41 (2) that forms the main image with the “reverse printing white use mode” is used.

### Optimum Printing Pattern

With the printer 1 of the embodiment, the user is able to select one of three types of image quality levels, that is, a “high quality mode (image quality level 1)”, a “normal mode (image quality level 2), and a “quick mode (image quality level 3)” depending on the purpose. By differentiating the printing pattern according to the image quality level, an image can be printed with higher image quality in the order of “the high quality mode, the normal mode, and the quick mode”, and an image can be printed with faster speed in the order of “the quick mode, the normal mode, and the high quality mode”. However, without being limited thereto, for example, a printer may have only one type of image quality level.

The printer 1 is able to print image with approximately the same image quality by a plurality of types of printing patterns. However, the optimum printing pattern among the plurality of types of printing patterns of printing images of approximately the same image quality naturally differs for each model of printer 1, and also differs for each unit of printer 1 due to the influence of differences in the characteristics of the head 41 or the transport unit 20.

Therefore, in the embodiment, the optimum printing pattern at each image quality level 1 to 3 is determined for each unit of the printer 1 (that is, the printing pattern that is adopted by each printer 1) during the manufacturing process (mass production process) of the printer 1. However, without being limited thereto, the optimum printing pattern at each image quality level 1 to 3 may be determined for each model of the printer 1 in the design process of the printer 1. Further, the optimum printing pattern may be re-determined once again during maintenance.

The determination method of the optimum printing pattern at image quality level 2 (normal mode) will be described below as an example.

### Printing Patterns of Adoption Candidates

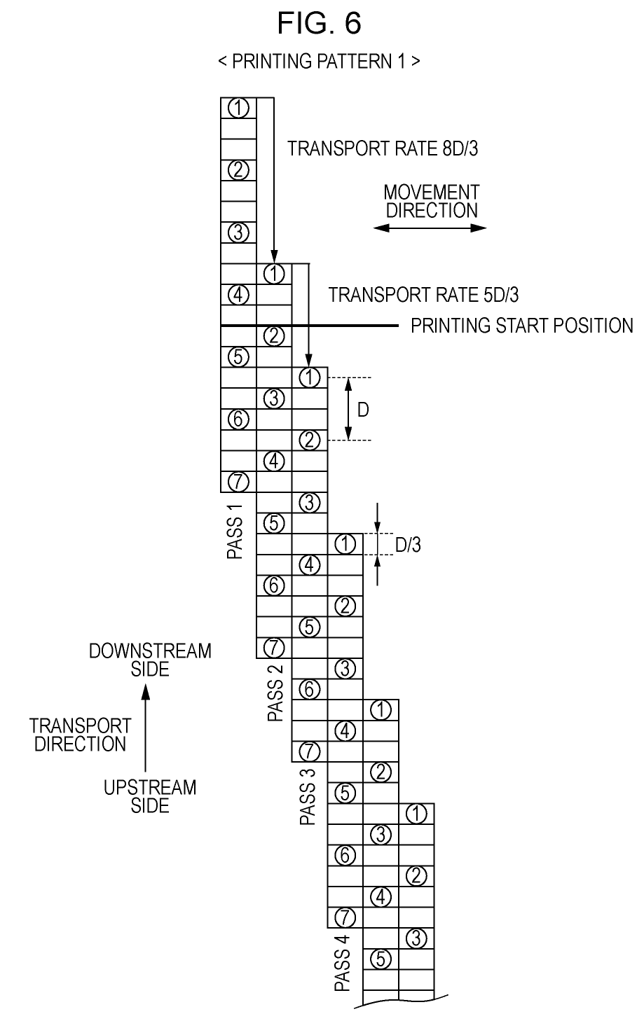

FIGS. 6 to 10 are diagrams that describe printing patterns 1 to 5 that are the adoption candidates. Here, five types of printing patterns 1 to 5 are given as examples of printing patterns of printing an image with image quality level 2. Here, as illustrated in FIGS. 4A and 4B and 5A and 5B, the printer 1 of the embodiment prints one image (main image or background image) with one head 41. Accordingly, in FIGS. 6 to 10, printing patterns in which one image is printed by one head 41 are illustrated. In the drawings, in order to simplify description, the number of nozzles that belong to one nozzle row (equivalent to the color nozzle row Co or the white nozzle row W) is represented as being reduced to seven (the nozzle numbers are within the circles in the drawings).

FIG. 6 is a diagram that describes printing pattern 1. Printing pattern 1 is a printing pattern of printing one raster line with one nozzle. The printing resolution in the transport direction is three times the resolution (example: 540 dpi) of the nozzle pitch D of the nozzle row (example: 180 dpi). That is, two raster lines are formed between the raster lines that are formed with one pass. Therefore, the medium transport rate of one pass is a “repeating of 8 D/3, 5 D/3, and 8 D/3”.

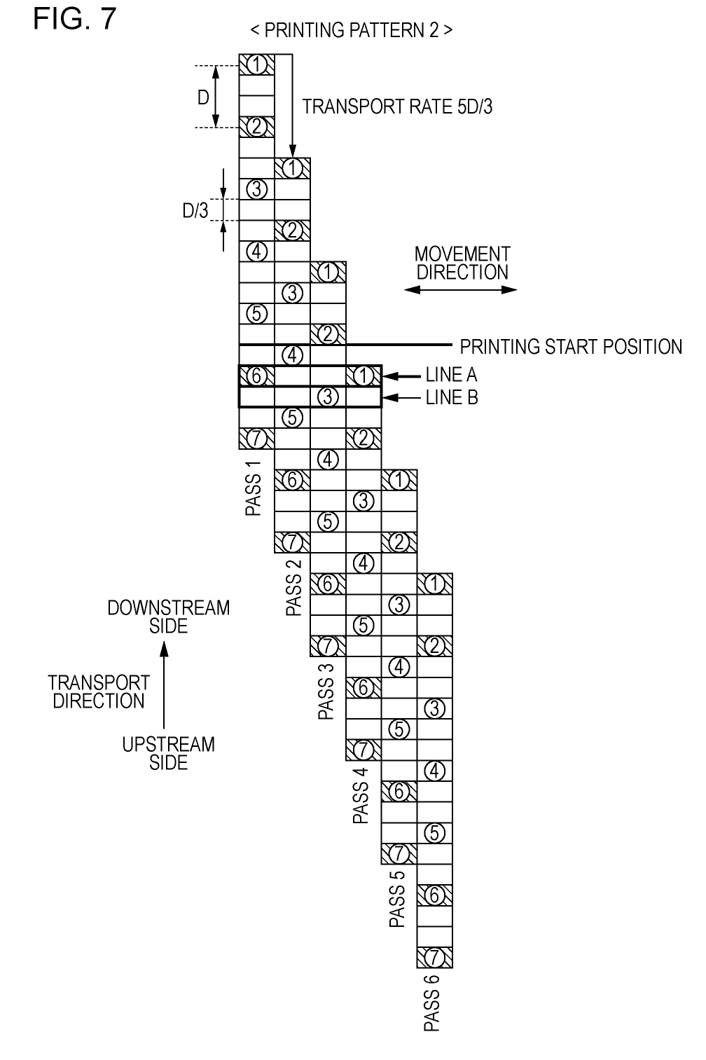

FIG. 7 is a diagram that describes printing pattern 2. Printing pattern 2 prints a portion of the raster lines with two nozzles (for example, line A in the drawing), and prints a portion of the raster lines with one nozzle (for example, line B in the drawing). With the raster lines that are printed by two nozzles, even if one nozzle is faulty, since the dots are correctly formed by the other nozzle, a decrease in the image quality is mitigated. One raster line is formed by two nozzles through two end portion nozzles to the downstream side of the transport direction (#1 and #2) and two end portion nozzles to the upstream side (#6 and #7) becoming pairs. The printing resolution in the transport direction is the same as printing pattern 1 (three times the nozzle pitch D), and the medium transport rate of one pass is “5 D/3”.

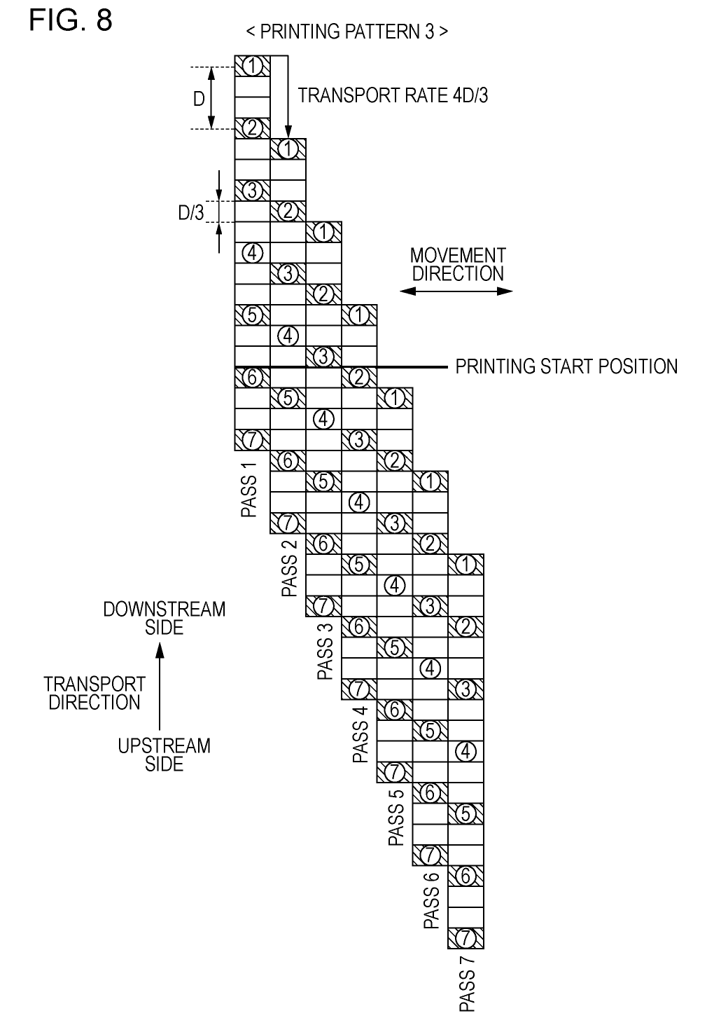

FIG. 8 is a diagram that describes printing pattern 3. In printing pattern 3, the number of raster lines that are printed by two nozzles is greater than in printing pattern 2. One raster line is formed by two nozzles by three end portion nozzles to the downstream side of the transport direction (#1 to #3) and three end portion nozzles to the upstream side (#5 to #7) forming pairs. The printing resolution in the transport direction is the same as in printing patterns 1 and 2 (three times the nozzle pitch D), and the medium transport rate of one pass is “4 D/3”.

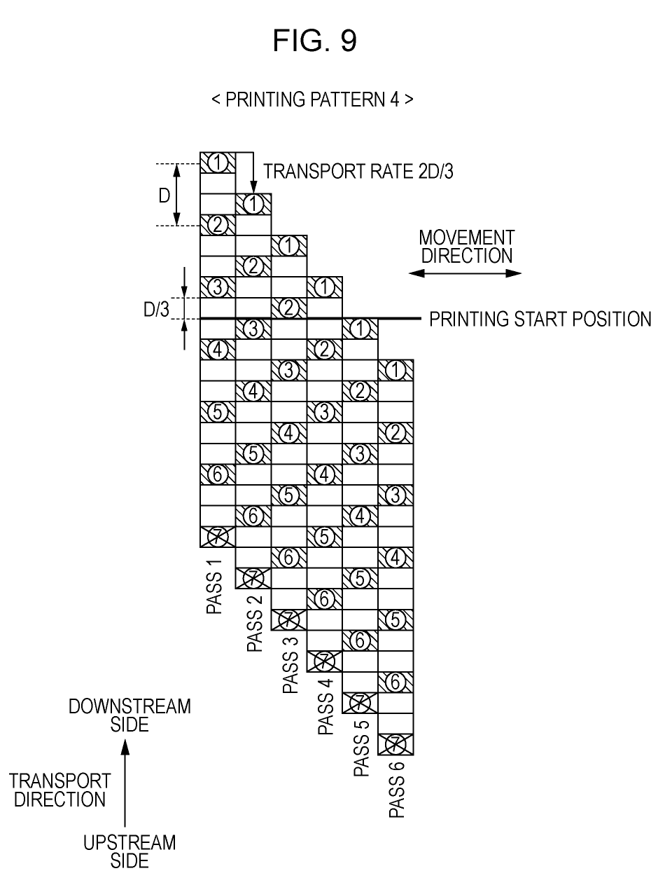

FIG. 9 is a diagram that describes printing pattern 4. Printing pattern 4 is a printing pattern in which all raster lines are printed by two nozzles. The printing resolution in the transport direction is the same as printing patterns 1 to 3 (three times the nozzle pitch D), and the medium transport rate of one pass is “2 D/3”. Here, the nozzle #7 is an unused nozzle.

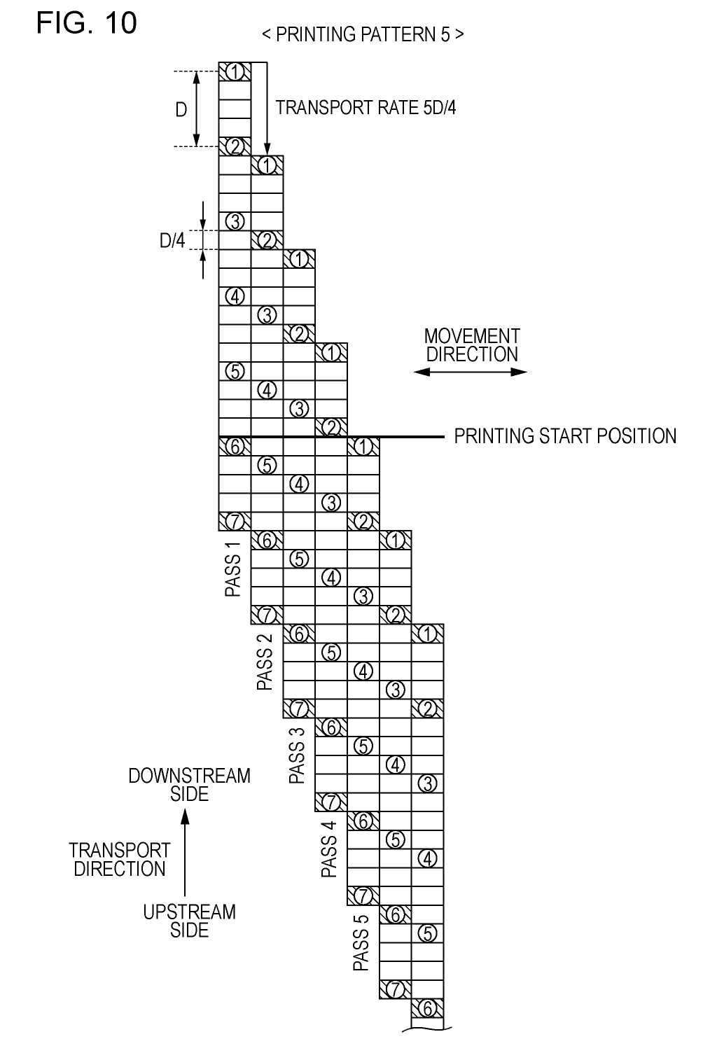

FIG. 10 is a diagram that describes printing pattern 5. Printing pattern 5 is a printing pattern in which the printing resolution in the transport direction is higher than in printing patterns 1 to 4, and the printing resolution in the transport direction is four times the nozzle pitch D. Further, the two end portion nozzles to the downstream side of the transport direction (#1 and #2) and the two end portion nozzles to the upstream side (#6 and #7) form pairs, and one raster line is printed by the two nozzles. Accordingly, the medium transport rate of one pass is “5 D/4”.

In such a manner, with printing patterns 1 to 5 of printing an image of image quality level 2, the number of raster lines that are formed by two nozzles may be different, and the printing resolution may be slightly different. While normally, the printing speed is slower when the number of raster lines that are formed by two nozzles is greater and the printing resolution is higher, the image quality of the image tends to improve. However, there are cases when such tendencies are not the case, depending on differences in the characteristics of each unit of the printer 1.

For example, in a case when the nozzle #6 is a faulty nozzle, while with printing patterns 2 and 3 in which one raster line is printed by two nozzles that include the nozzle #6, approximately the same image quality is obtained, the printing speed for printing pattern 3 is slower than for the printing pattern 2. Accordingly, if printing pattern 3 is adopted, the printing speed becomes unnecessarily slow.

Therefore, in the embodiment, the optimum printing pattern is determined based on the “image quality of the image” that the printer 1 printed by each printing pattern in reality, and the “printing speed” of each printing pattern.

### Determination of Optimum Printing Pattern in White Use Mode

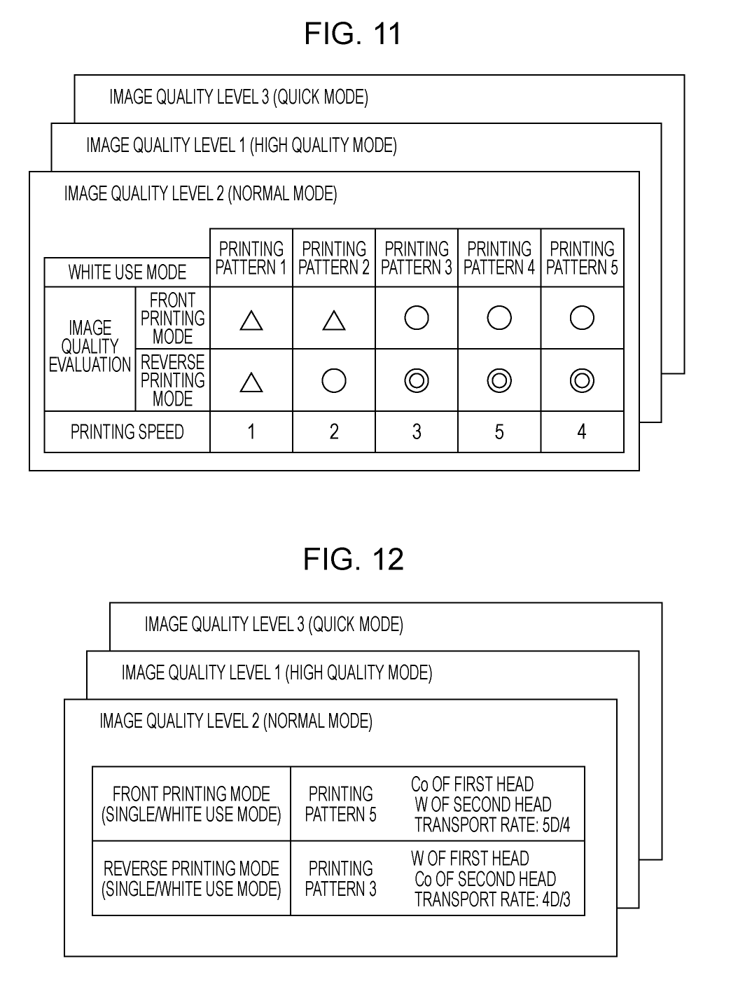

FIG. 11 is a diagram that illustrates the evaluation results of printing patterns 1 to 5 that are the adoption candidates at image quality level 2 in the white use mode. As illustrated in FIG. 4, the printer 1 of the embodiment forms the main image by the first head 41 (1) in the case of the front printing white use mode, and forms the main image by the second head 41 (2) in the case of the reverse printing white use mode. If the head 41 that forms the main image is different, since the characteristics of the head 41 (for example, the manner in which a faulty nozzle is generated) are different, the optimum printing pattern is different.

Accordingly, with the printer 1 of the embodiment, the optimum printing pattern differs between the front printing white use mode and the reverse printing white use mode. Therefore, with respect to the printer 1 of the embodiment, the optimum printing pattern with the front printing white use mode and the optimum printing pattern with the reverse printing white use mode are determined individually.

The printing speed can be evaluated based on the medium transport rate of each printing pattern. As illustrated in FIG. 11, the printing speed is fastest from printing pattern 1, 2, 3, 5, to 4 in order. Here, the evaluation of the printing speed is the same for the front printing white use mode and the reverse printing white use mode.

Further, in order to evaluate the image quality of an image, the examiner causes the printer 1 that is the examination target to print five test patterns by printing patterns 1 to 5 in the front printing white use mode (test patterns in which the background image and the main image overlap, not shown) and five test patterns of printing patterns 1 to 5 in the reverse printing white use mode during the manufacturing process.

The examiner then evaluates the image quality of the test patterns (main images) that are printed by the printer 1 that is the examination target. Here, as illustrated in FIG. 11, there are three levels of image quality evaluation with an image, wherein “A” is when the image quality is excellent, “B” is when the image quality is good, and “C” when the image quality is normal. Here, the examiner evaluates the image quality by viewing the main image from the printing face side with the test patterns of the front printing white use mode, and evaluates the image quality by viewing the main image from the opposite side to the printing face side with test patterns of the reverse printing white use mode.

According to the evaluation results of FIG. 11, with the front printing white use mode, the image quality evaluation of printing patterns 1 and 2 is normal (C), the image quality evaluation of printing patterns 3 and 4 is good (B), and the image quality evaluation of printing pattern 5 is excellent (A). Meanwhile, with the reverse printing white use mode, the image quality evaluation of printing pattern 1 is normal (C), the image quality evaluation of printing pattern 2 is good (B), and image quality evaluation of printing patterns 3 to 5 is excellent (A).

In a case when such evaluation results are obtained, for example, “printing pattern 5” with which the image quality evaluation is the best and the printing speed is fourth may be determined as the optimum printing pattern for the front printing white use mode, and “printing pattern 3” that has the fastest printing speed out of printing patterns 3 to 5 with which the image quality evaluation is excellent may be determined as the optimum printing pattern for the reverse printing white use mode.

### Determination of Optimum Printing Pattern in Single Mode

In the case of the front printing single mode, the printer 1 of the embodiment forms the main image by the first head 41 (1) similarly to the case of the front printing white use mode, and in the case of the reverse printing single mode, the main image is formed by the second head 41 (2) similarly to the case of the reverse printing white use mode. In a case when the main image is formed by the same head 41, since the characteristics of the head 41 (for example, the manner in which a faulty nozzle is generated) are the same, the optimum printing pattern becomes the same.

That is, the optimum printing pattern between both the “front printing white use mode” and the “front printing single mode” of forming the main image by the first head 41 (1) becomes the same, and the optimum printing pattern between both the “reverse printing white use mode” and the “reverse printing single mode” of forming the main image by the second head 41 (2) becomes the same.

Therefore, with the printer 1 of the embodiment, the printing pattern of forming the main image (and the background image) by the “front printing white use mode” and the printing pattern of forming the main image by the “front printing single mode” are the same, and the printing pattern of forming the main image (and the background image) by the reverse printing white use mode” and the printing pattern of forming the main image by the “reverse printing single mode” are the same.

Accordingly, the examiner does not cause the printer 1 that is the examination target to perform printing of the single mode test patterns. Furthermore, the examiner determines the optimum printing pattern for the front printing single mode to be “printing pattern 5” as with the front printing white use mode, and determines the optimum printing pattern for the reverse printing single mode to be “printing pattern 3” as with the reverse printing white use mode.

### Storage in Memory 13

FIG. 12 is a diagram that describes a “printing pattern table” that is stored in the memory 13 of the printer 1. When the printer 1 that is the examination target actually prints an image for the user, the printing pattern table is stored in the memory 13 of the printer 1 that is the examination target so that printing is performed by the optimum printing pattern that is determined according to the printing mode.

A printing pattern table is provided for each image quality level, and each printing pattern table stores the optimum printing pattern for the front printing mode (printing pattern 5) and the optimum printing pattern for the reverse printing mode (printing pattern 3). Here, a printing pattern table may also store other information for executing printing (for example, the head to be used, the medium transport rate, and the like). In so doing, the printer 1 in which the optimum printing pattern for each printing mode (printing pattern that is adopted for each printing mode) is stored is shipped out to the user.

### Printing Method

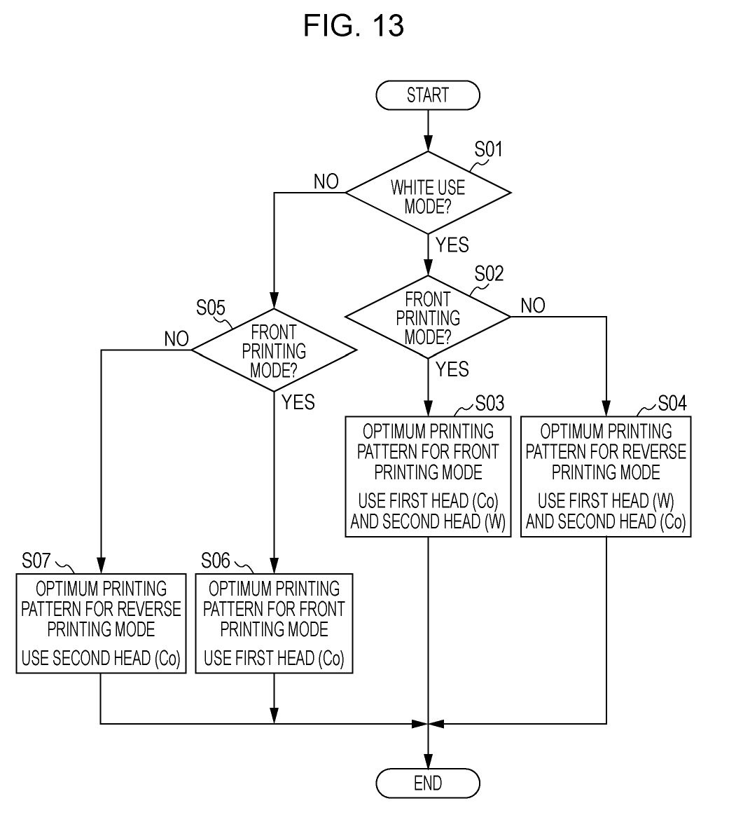

FIG. 13 is a flowchart of a printing method by the printer 1 of the embodiment. As illustrated in FIG. 3, the printer 1 of the embodiment includes four printing modes. Therefore, when the printing instruction and the printing data are received from the computer 70, the controller 10 of the printer 1 determines by which printing mode the image is to be printed. For example, the controller 10 may determine the printing mode from the printing mode information that is set by the user or the printing mode information that is determined by a printer driver based on the printing data, or the controller 10 itself may determine the printing mode based on the printing data. Furthermore, the controller 10 controls the printing according to the printing mode that is determined.

Here, the printer driver that is installed on the computer 70 obtains a “printing pattern table (FIG. 12)” from the memory 13 of the printer 1 in order to create the printing data, and creates the printing data so that an image is printed by a printing pattern according to each printing mode.

To describe specifically using FIG. 13, the controller 10 first determines whether or not the printing mode is a “white use mode” (S01), and in a case when the printing mode is a white use mode (S01→Y), next determines whether or not the printing mode is a “front printing mode” (S02).

In a case when the printing mode is a front printing mode (S02→Y), that is, in the case of the “front printing white use mode”, the controller 10 prints the image by printing pattern 5 (refer to FIG. 12) using the color nozzle row Co of the first head 41 (1) and the white nozzle row W of the second head 41 (2) (S03).

On the other hand, in a case when the printing mode is not a front printing mode (S02→N), that is, in the case of the “reverse printing white use mode”, the controller 10 prints the image by printing pattern 3 using the white nozzle row W of the first head 41 (1) and the color nozzle row Co of the second head 41 (2) (S04).

Further, in a case when the printing mode is not a white use mode (S01→N) and is a front printing mode (S05→Y), that is, in the case of the “front printing single mode”, the controller 10 prints the image by printing pattern 5 using the color nozzle row Co of the first head 41 (1) (S06).

On the other hand, in a case when the printing mode is not a white use mode (S01→N) and is not a front printing mode (S05→N), that is, in the case of the “reverse printing single mode”, the controller 10 prints the image by printing pattern 3 using the color nozzle row Co of the second head 41 (2) (S07).

In so doing, an image is printed by the optimum printing pattern according to each printing mode.

### CONCLUSION

1

The printer 1 of the embodiments includes a “white use mode (equivalent to a first mode)” of forming a main image that is formed using either head 41 out of the first head 41 (1) (equivalent to one nozzle row group) and the second head 41 (2) (equivalent to other nozzle row groups) and a background image that is formed using the other head 41 to be overlapping on a medium, and a “single mode (equivalent to a second mode)” of forming a main image using either head 41 out of the first head 41 (1) and the second head 41 (2) without forming a background image.

With the single mode, while it is possible to form the main image using both the first head 41 (1) and the second head 41 (2), the printer 1 of the embodiment uses only one of the head 41 out of the first head 41 (1) and the second head 41 (2).

With the head 41, the ink discharge characteristics vary between each head 41 due to differences in the characteristics of members or assembly errors. For example, there may be a case when one head 41 may have a greater ink discharge amount compared to other heads 41, and with another head 41, the landing positions of dots are out of line in the movement direction compared to other heads 41. In such a case, the image quality is different between the part of the image that is printed by the first head 41 (1) and the part of the image that is printed by the second head 41 (1).

Therefore, if it is supposed that a main image is printed using the two heads 41 (1) and 41 (2) in the case of the single mode, the image quality of the main image decreases due to differences in the image quality between the part of the image that is printed by the first head 41 (1) and the part of the image that is printed by the second head 41 (2).

Further, since the nozzle pitch D of the nozzle rows is miniscule, the relative positional relationship between the first head 41 (1) and the second head 41 (2) in the transport direction tends to deviate. For example, if the two heads 41 (1) and 41 (2) are attached to be close together in the transport direction, the part of the image that is printed at the juncture between the heads 41 becomes dark, and if the two heads 41 (1) and 41 (2) are attached apart from each other in transport direction, the part of the image that is printed at the juncture between the heads 41 becomes pale.

Therefore, in the case of the single mode, if it is assumed that the main image is printed using the two heads 41 (1) and 41 (2), the part of the image that is printed at the juncture between the heads 41 stands out, and the image quality of the main image decreases.

Therefore, by executing the single mode using either one of the two heads 41 (1) and 41 (2) as with the printer 1 of the embodiment, it is possible to suppress a decrease in the image quality of the main image due to differences in the characteristics of the heads 41 or the juncture between the heads 41.

Further, with the printer 1, normally, transport rollers are provided to the upstream side of the head 41 in the transport direction, and paper discharge rollers are provided to the downstream side of the head 41 in the transport direction (not shown). When the central portion of the medium is being printed, printing is performed in a state in which the medium is interposed between the transport rollers and the paper discharge rollers. In such a case, the medium does not rise above a platen (member that retains the medium from below), and the distance from the nozzle face of the head 41 to the medium (hereinafter, paper gap) can be kept constant.

However, when the upper end portion (downstream side end portion) of the medium is being printed, the medium is only interposed by the transport rollers, and when the lower end portion (upstream side end portion) of the medium is being printed, the medium is only interposed by the paper discharge rollers. In such a case, the medium tends to rise above the platen, and the paper gap varies. If the paper gap varies, the landing positions of the dots become out of line.

In particularly, if printing of end portions is performed using the two heads 41, the distance from the end portion of the medium to each roller in the transport direction becomes longer, and the variation amount of the paper gap increases. In such a case, deviations of the dot landing positions increase, and the image quality of the image decreases further.

Therefore, in the case of the single mode, as with the printer 1 of the embodiment, the distance from the end portion of the medium to each roller in the transport direction can be shortened by using either one of the two heads 41 (1) and 41 (2), and the variation amount of the paper gap when an end portion is printed can be decreased. As a result, it is possible to limit deviations in dot landing positions, and to suppress a decrease in the image quality of the main image.

Further, by executing the single mode using either one of the two heads 41 (1) and 41 (2), the configuration (number and type) of the head 41 that prints the main image can be made the same between the single mode and the white use mode. It is therefore possible to print the main image by a single mode of using the same head 41 before the actual printing by the white use mode, to verify the image quality of the main image. Specifically, it is possible to verify the occurrence of faulty nozzles, or to verify the tone of the main image by printing the main image on a white medium. Further, since white ink is more expensive than color ink, the consumption of white ink can be suppressed by verifying the image quality of the main image by the single mode before the actual printing.

2

The printer 1 of the embodiment includes a “front printing white use mode (equivalent to a third mode)” of forming an image that is viewed from the image formation side in the white use mode, forming a main image using the first head 41 (1), and forming a background image using the second head 41 (2), and a “reverse printing white use mode (equivalent to a fourth mode)” of forming an image that is viewed from the opposite side to the image formation side in the white use mode, forming a background image using the first head 41 (1), and forming a main image using the second head 41 (2).

Furthermore, the printing pattern (dot formation pattern) in a case when the main image is formed using the first head 41 (1) in the single mode (front printing single mode) is the same as the printing pattern of forming the main image in the front printing white use mode, and the printing pattern in a case when the main image is formed using the second head 41 (2) in the single mode (reverse printing single mode) is the same as the printing pattern of forming the main image in the reverse printing white use mode.

Since forming image by the same head 41 is to form an image with the head 41 with the same characteristics (for example, a head 41 in which the manner in which a faulty nozzle is generated is the same), the optimum printing pattern becomes the same.

Therefore, by making the printing pattern the same for the front printing white use mode and the front printing single mode of printing the main image by the first head 41 (1) and the printing pattern the same for the reverse printing white use mode and the reverse printing single mode of printing the main image by the second head 41 (2), the image quality of the main image of the white use mode and the image quality of the main image of the single mode is approximately the same. That is, the image quality of the main image can be homogenized regardless of the printing mode.

Further, if the optimum printing pattern of either the white use mode or the single mode is determined, since the optimum printing pattern of the other mode is also determined, the process of determining the optimum printing pattern in the manufacturing process and the like of the printer 1 can be simplified.

Further, since the information relating to printing patterns in the white use mode and the single mode is shared, for example the storage capacity of the memory 13 in which the printing pattern tables (FIG. 12) are stored can be decreased.

In other words, by using only one of the two heads 41 in the case of the single mode, the head 41 that forms the main image becomes the same for the single mode and the white use mode, and the printing pattern can be made the same between the single mode and the white use mode.

3

The printer 1 of the embodiment forms a main image by using the first head 41 (1) similarly to the front printing white use mode in a case when an image that is viewed from the image formation side in the single mode is formed (with the front printing single mode), and forms a main image using the second head 41 (2) similarly to the reverse white use mode in a case when an image that is viewed from the opposite side to the image formation side in the single mode is formed (with the reverse printing single mode). That is, a main image is formed using the first head 41 (1) for the front printing mode and using the second head 41 (2) for the reverse printing mode, regardless of whether the white use mode or the single mode is adopted.

In so doing, disproportionate use of either one of the two heads in the single mode can be prevented, and the deviation in the use frequency of the four color nozzle row (YMCK) of the first head 41 (1) and the four color nozzle row of the second head 41 (2) can be reduced. Accordingly, the life of each of the four color nozzle rows (YMCK) of the two heads 41 can be increased.

Further, if it is assumed that the head 41 that forms the main image is the same for the front printing single mode and the reverse printing white use mode, and the head 41 that forms the main image is the same for the reverse printing single mode and the front printing white use mode, the printing pattern for the front printing single mode and the reverse printing white use mode is the same, and the printing pattern for the reverse printing single mode and the front printing white use mode is the same.

With the reverse printing mode, since the main image is visible via the medium, normally, poor image quality does not stand out as much as with the front printing mode. That is, with the reverse printing mode, even if a printing pattern with which the image quality tends to decrease but which can print at high speed (for example, printing pattern 1 of FIG. 6) is adopted, the poor image quality tends not to stand out.

Accordingly, in a case when the printing pattern for the front printing single mode and the reverse printing white use mode is the same and the printing pattern for the reverse printing single mode and the front printing white use mode is the same, the printing time becomes unnecessarily long with the reverse printing mode if a printing pattern with which the image quality tends not to decrease is adopted to match the front printing mode, and the image quality with the front printing mode decreases if a fast printing pattern but with which the image quality tends to decrease is adopted to match the reverse printing mode.

Therefore, by unifying the head 41 that forms the main image with the front printing mode and unifying the head 41 that forms the main image with the reverse printing mode as with the printer 1 of the embodiment, the printing pattern of the front printing mode can be unified and the printing pattern of the reverse printing mode can be unified regardless of whether the white use mode or the single mode is adopted. A printing pattern with which the image quality tends not to decrease can then be adopted with the front printing mode and a fast printing mode but with which the image quality tends to decrease can be adopted with the reverse printing mode, and a printing pattern that speeds up the printing speed as much as possible while reliably suppressing a decrease in the image quality of the main image can be adopted.

4

The printer 1 of the embodiment uses UV ink (equivalent to photocurable ink that is cured when light is irradiated), and as illustrated in FIG. 2, and includes the provisional irradiation unit 51 (equivalent to a light irradiation unit) that is placed to extend from the end portion of the first head 41 (1) to the downstream side in the transport direction to the end portion of the second head 41 (2) to the upstream side in the transport direction in at least the transport direction, and the provisional irradiation unit 51 and the two heads 41 move in the movement direction with respect to the medium during the discharge action.

Furthermore, since the first head 41 (1) and the second head 41 (2) are positioned out of line in the movement direction, as illustrated in FIG. 2A, a distance X1 from the first head 41 (1) to the provisional irradiation unit 51 in the movement direction and a distance X2 from the second head 41 (2) to the provisional irradiation unit 51 in the movement direction are different. In such a case, the time taken between the UV ink that is discharged from the first head 41 (1) landing on the medium to ultraviolet rays being irradiated by the provisional irradiation unit 51 and the time taken from the UV ink that is discharged from the second head 41 (2) landing on the medium to ultraviolet rays being irradiated by the provisional irradiation unit 51 are different.

UV ink lands on the medium S and spreads across the surface of the medium S. Therefore, if the time from when the UV ink lands on the medium S and ultraviolet rays are irradiated by the provisional irradiation unit 51 is different, the dot size becomes slightly different. That is, the dot size that is formed by the first head 41 (1) and the dot size that is formed by the second head 41 (2) become slightly different, and the image quality becomes different between parts of the image which are printed by the first head 41 (1) and part of the image which are printed by the second head 41 (2). Therefore, if it is assumed that a main image is formed using the two heads 41 in the case of the single mode, the image quality of the main image decreases due to the differences in the parts of the image which are printed by the first head 41 (1) and parts of the image which are printed by the second head 41 (2).

Therefore, by executing the single mode using either one of the two heads 41 as with the printer 1 of the embodiment, a decrease in the image quality of the main image can be suppressed even in a case when there are discrepancies between the dot sizes of the UV ink due to the head 41. That is, even in a case when differences in the image quality of each image due to two heads 41 tend to increase by using UV ink or the like, according to the printer 1 of the embodiment, a decrease in the image quality of the main image can be suppressed.

### MODIFICATION EXAMPLES

### Modification Example 1

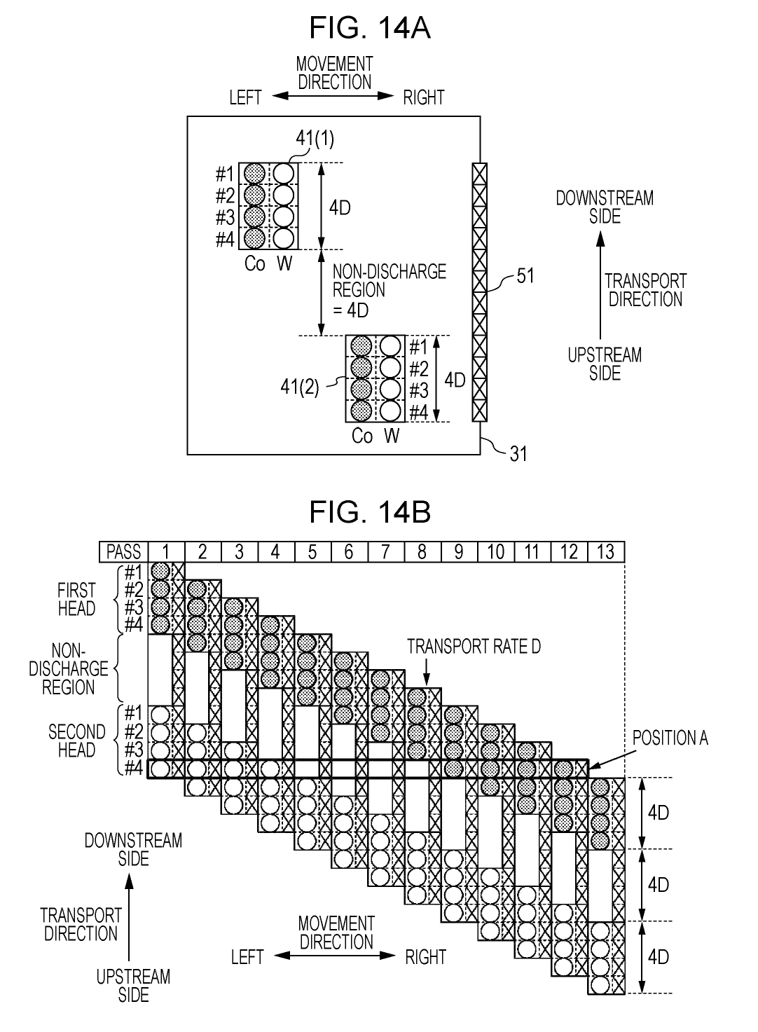

FIG. 14A is a diagram that describes the placement of the head 41 of a modification example, and FIG. 14B is a diagram that describes a printing method of the modification example. While in the example described above, nozzles are lined up from the first head 41 (1) to the second head 41 (2) in the transport direction with the nozzle pitch D as illustrated in FIG. 2, without being limited thereto, the first head 41 (1) and the second head 41 (2) may be separated in the transport direction as illustrated in FIG. 14A. Here, in FIG. 14A, the length of a region between the first head 41 (1) and the second head 41 (2) (hereinafter, non-discharge region) in the transport direction “4 D” is equal to the lengths of the nozzle rows of each head 41 in the transport direction “4 D”.

FIG. 14B is a diagram that describes a printing method of the front printing white use mode, and illustrates a printing method of forming a main image by the color nozzle row Co of the first head 41 (1) and forming a background image by the white nozzle row W of the second head 41 (2). Here, in the diagram, the number of nozzles that belong to a nozzle row is reduced, the two nozzle rows Co and W are illustrated as one nozzle row, and the medium transport rate is the nozzle pitch D.

For example, a background image is formed on the medium part at a position A illustrated in FIG. 14B by the white nozzle row W of the second head 41 (2) during passes 1 to 4. The medium part at the position A then faces the non-discharge region. Meanwhile, since ink is not discharged to the medium part at the position A, the main image on the medium part at the position A is sufficiently cured by ultraviolet rays from the provisional irradiation unit 51. Finally, a background image is formed to overlap on the main image on the medium part at the position A during passes 9 to 12.

By providing a non-discharge region to which ink is not discharged between the first head 41 (1) and the second head 41 (2) in the transport direction in such a manner, the length of time from when the lower layer image is printed to printing the upper layer image to overlap can be prolonged.

In so doing, it is possible to print the upper layer image to overlap in a state in which the lower layer image by UV ink, for example, is sufficiently cured, and a decrease in the image quality of the image can be suppressed. Further, even in a case when UV ink is not used, it is possible to print the upper layer image to overlap in a state in which the lower layer image has sufficiently dried, and it is possible to suppress bleeding of the image or the mixing of colors, and a decrease in the image quality of the image can be suppressed. Here, by making the length of the non-discharge region in the transport direction an integral multiple of the medium transport rate, the length of time from when the lower layer image is printed to the upper layer image is printed to overlap can be kept constant.

Further, the printer 1 of the embodiment uses only one of the two heads 41 in the single mode. Therefore, separation of the first head 41 (1) and the second head 41 (2) in the transport direction is irrelevant, and problems such as the printing control becoming complicated or the printing time becoming longer do not occur.

### Modification Example 2

While in the examples described above, the printing pattern is the same for the front printing white use mode and the front printing single mode that uses the same first head 41 and the printing pattern is the same for the reverse printing white use mode and the reverse printing single mode using the same second head 41 (2), the embodiment of the invention is not limited thereto. For example, the printing pattern may be different for each printing mode.

Further, while the main is formed by using the first head 41 (1) in the front printing mode and using the second head 41 (2) in the reverse printing mode in the example described above, the embodiment of the invention is not limited thereto. For example, the main image may be formed by using different heads 41 for the front printing single mode and the front printing white use mode, or the main image may be formed by using different heads 41 for the reverse printing single mode and the reverse printing white use mode.

Further, while the optimum printing pattern that is determined based on a test pattern that is printed by the white use mode is also adopted for the single mode in the example described above, the embodiment of the invention is not limited thereto. For example, an optimum printing pattern that is determined based on a test pattern that is printed by the single mode may also be adopted for the white use mode. In so doing, the consumption of the relatively expensive white ink can be suppressed during the manufacturing process (when determining the optimum printing pattern).

### Modification Example 3

While the background image is printed with only white ink in the examples described above, the embodiment of the invention is not limited thereto. Since the color of the white differs slightly depending on the type of white ink, if printing is performed with only white ink, the color of the white ink itself becomes the color of the background image. Further, a background image that is not simply white but that has slight coloring may also be desired. Therefore, the desired white background image (an adjusted white background image) may be printed by using small amounts of colored ink (three colors of any of YMCK) along with the white ink. Further, conversely, the slight coloring that is included in the white ink may be cancelled out by mixing four colors of ink to the white ink. In such cases, for example with the printing method of FIG. 4A, the color nozzle row Co of the second printing head 41 (2) is the nozzle row that adjusts the coloring of the background image.

Further, without limiting the background image to white, the background image may be printed by colored ink other than white (for example, metallic ink).

### Other Embodiments

While the embodiments described above mainly describe an image forming device, such embodiments also include disclosure of an image forming method and the like. Further, the embodiments described above are for simplifying understanding of the invention, and are not to be interpreted as limiting the invention. Needless to say, the invention may be changed or improved without departing from the gist thereof, and the invention includes equivalents thereof.

### Regarding Ink

While ultraviolet curable ink (UV ink) is exemplified as a photocurable ink in the embodiments described above, without being limited thereto, the ink may be an ink that is cured when visible light is irradiated. Further, without limiting to photocurable ink, the ink may be, for example, a water-based ink or an organic solvent ink that penetrates the medium.

### Regarding Printer

While a printer that repeats a discharge action of discharging ink from a head that moves in the movement direction and a transport action of transporting the medium in the transport direction is exemplified in the embodiments described above, the embodiment of the invention is not limited thereto. For example, the printer may be a printer that forms an image by repeating an action of forming an image while moving the head in the medium transport direction and an action of moving the head in the paper width direction before transporting the portions of the medium which are not yet printed to the printing region.

### Regarding White

“White” in the specification is not limited to white in the strict sense of being the surface color of an object that reflects 100% of the wavelengths of visible rays, and includes colors that are generally referred to as white such as so-called “whitish colors”. “White” refers, for example, to (1) a color within a hue range in which the mark in the Lab system is the circumference of a radius of 20 and the interior thereof on the a*b* plane and the L* is represented by 70 or greater in a case when the color is measured using the photometer eye-one Pro manufactured by X-rite, Inc. with color measurement mode: spot color measurement, light source: D50, backing: Black, and printing medium: transparent film, (2) a color within a hue range in which the mark in a Lab system is a circumference of a radius of 20 and on the inside thereof on an a*b* plane and the L* is represented by 70 or greater in a case when the color is measured using the photometer CM2022 manufactured by Konica Minolta Holdings, Inc. with measurement mode D field of view of 502°, SCF mode, and white background, or (3) the color of the ink that is used as the background of an image as described in JP-A-2004-306591, and is not limited to pure white if being used as a background.

What is claimed is:

1. An image forming device comprising:
a plurality of nozzle row groups in which one nozzle row group is positioned out of line with respect to other nozzle row groups to one side in a predetermined direction, wherein the plurality of nozzle rows in each of the nozzle row groups are lined up in a direction that intersects the predetermined direction, and a plurality of nozzles in each of the nozzle rows that discharge ink are lined up in the predetermined direction and the plurality of nozzles are in communication with a common ink chamber; and
a control unit that repeatedly executes a discharge action of discharging ink from the nozzles while relatively moving the plurality of nozzle row groups and a medium in the intersecting direction and a transport action of moving a relative position of the medium with respect to the plurality of nozzle row groups in the predetermined direction,
the device including:
a first mode of overlapping and forming a main image that is formed using either nozzle row group out of the one nozzle row group and the other nozzle row groups and a background image that is formed using the other nozzle row group out of the one nozzle row group and the other nozzle row groups on the medium; and
a second mode of forming the main image on the medium without forming the background image using one nozzle row group out of the one nozzle row group and the other nozzle row groups.

2. The image forming device according to claim 1,
wherein the control unit moves the relative position of the medium with respect to the plurality of nozzle row groups to the one side in the predetermined direction in the transport action,
the device including:
a third mode of forming an image that is visible from an image formation side in the first mode, wherein the main image is formed using either nozzle row group and the background image is formed using the other nozzle row group; and
a fourth mode of forming an image that is visible from an opposite side to the image formation side in the first mode, wherein the background image is formed using either nozzle row group and the main image is formed using the other nozzle row group,
wherein a dot formation pattern in a case when the main image is formed using the one nozzle row group in the second mode is a same as a dot formation pattern of forming the main image in the third mode, and
a dot formation pattern in a case when the main image is formed using the other nozzle row groups in the second mode is a same as a dot formation pattern of forming the main image in the fourth mode.

3. The image forming device according to claim 1,
wherein the control unit moves the relative position of the medium with respect to the plurality of nozzle row groups to the one side in the predetermined direction in the transport action,
the device including:
a third mode of forming an image that is visible from the image formation side in the first mode, wherein the main image is formed using the one nozzle row group and the background image is formed using the other nozzle row groups; and
a fourth mode of forming an image that is visible from the opposite side to the image formation side in the first mode, wherein the background image is formed using the one nozzle row group and the main image is formed using the other nozzle row groups,
wherein the main image is formed using the one nozzle row group in a case when an image that is visible from the image formation side is formed in the second mode, and
the main image is formed using the other nozzle row groups in a case when an image that is visible from the opposite side to the image formation side is formed in the second mode.

4. The image forming device according to claim 1,
wherein ink that is discharged from the plurality of nozzles is photocurable ink that is cured when light is irradiated,
wherein a light irradiation unit is further comprised that irradiates light on the photocurable ink, which is placed to extend from an end portion of the one side of the predetermined direction of the one nozzle row group to an end portion of the other side in the predetermined direction of the other nozzle row groups in at least the predetermined direction,
wherein in the discharge action, the control unit relatively moves the light irradiation unit, the plurality of nozzle row groups, and the medium in the intersecting direction, and
the one nozzle row group and the other nozzle row groups are positioned out of line in the intersecting direction.

5. The image forming device according to claim 1,
wherein a non-discharge region in which the ink is not discharged is provided between the one nozzle row group and the other nozzle row groups in the predetermined direction.

6. An image forming method for an image forming device that includes a plurality of nozzle row groups in which one nozzle row group is positioned out of line with respect to other nozzle row groups to one side in a predetermined direction, wherein the plurality of nozzle rows in each of the nozzle row groups are lined up in a direction that intersects the predetermined direction, and a plurality of nozzles that discharge ink are lined up in the predetermined direction and the plurality of nozzles in each of the nozzle rows are in communication with a common ink chamber; and a control unit that repeatedly executes a discharge action of discharging ink from the nozzles while relatively moving the plurality of nozzle groups and a medium in the intersecting direction and a transport action of moving a relative position of the medium with respect to the plurality of nozzle row groups in the predetermined direction,
the method comprising:
forming the main image using either nozzle row group out of the one nozzle row group and the other nozzle row groups, and forming the background image using the other nozzle row group out of the one nozzle row group and the other nozzle row groups in a case when a main image and a background image are formed on the medium to be overlapping; and
forming the main image is formed using either nozzle row group out of the one nozzle row group and the other nozzle row groups in a case when the main image is formed on the medium without forming the background image.
